(19) United States
(12) Patent Application Publication
(10) Pub. No.: US 2023/0050947 A1
(43) Pub. Date: Feb. 16, 2023

(54) Device for Protecting Animals from Loud and Anxiety Inducing Sound

(71) Applicants: Tangi Jordan, Greenville, NC (US); Jerron Randall, Winterville, NC (US)

(72) Inventors: Tangi Jordan, Greenville, NC (US); Jerron Randall, Winterville, NC (US)

(21) Appl. No.: 17/500,365

(22) Filed: Oct. 13, 2021

Related U.S. Application Data
(60) Provisional application No. 63/233,566, filed on Aug. 16, 2021.

(51) Int. Cl. A01K 13/00

(52) U.S. Cl. CPC A01K 13/006

(57) ABSTRACT

The present invention relates to a protective device for protecting pet animals from loud and anxiety-inducing noises such as fireworks, gunshots and thunder. The device is configured to wrap over the ears and around the animal’s head and snugly fit in front of the chin using a fastener. More specifically, the device includes a top layer and a bottom layer, wherein the bottom layer includes a pair of pockets to store sound barrier ear pads that reduce sound decibels before entering the ears of the animal. The device can include a logo and a pair of dog ‘ears’ that are visually exposed for aesthetic appearance. The device can be configured in various sizes to accommodate all breeds and sizes of dogs.

### CROSS-REFERENCE TO RELATED APPLICATION

The present application claims priority to, and the benefit of, U.S. Provisional Application No. 63/233,566, which was filed on August 16^{th}, 2021 and is incorporated herein by reference in its entirety.

### FIELD OF THE INVENTION

The present invention relates generally to the field of ear protective gear for animals. More specifically, the present invention relates to a protective device that is designed to cover the ears of animals such as dogs, and protect their sensitive ears from loud and anxiety-inducing sounds. The protective device comprises curved-shaped layers that are broad at the center and narrow at the ends, designed to be secured over the ears and head of the pet, wherein the covering material snugly fits using a hook and loop fastener. Additionally, the protective covering features a pair of sleeves on each side on the inner layer of the covering for receiving and storing soundproof ear pads. The soundproof ear pads cover both the ears of a pet such as a dog, and act as a barrier between the environment and the ears of the animal, thereby protecting pets from anxiety-inducing noises such as fireworks, gunshots, thunder and the like. Accordingly, the present disclosure makes specific reference thereto. Nonetheless, it is to be appreciated that aspects of the present invention are also equally applicable to other like applications, devices, and methods of manufacture.

### BACKGROUND

By way of background, most pet owners know that dogs can have sensitive ears and are fearful of loud sounds. Noises such as thunderstorms, fireworks, gunshots, vacuum cleaners, lawn mowers, barking dogs, crying children, construction and others can quickly upset or frighten the dogs. The aforementioned loud noises and sounds not only frighten the dogs, but also cause feelings of anxiety among the dogs. The dogs may panic due to anxiety that is usually evident in their behavior. When the dogs are exposed to loud and noisy environments, the dogs can get panic attacks and may produce whining sounds as well as pant heavily when they are uncomfortable.

Generally during festivals and large gatherings, there is excessive noise or shouting that can make the animals shake and tremble in fear. For example, holidays such as New Year’s Eve and Fourth of July are especially bad for the pet owners, as dogs have been known to run away to avoid the sounds from fireworks. The pet exposure to noisy events is not only stressful for the pets, but is also stressful for the pet owners, as they are unable to make their pets feel safe during these noisy events.

Some pet owners may use a muffler-like covering to cover the ears of the dogs. However, conventional mufflers do not provide protection to dogs from noisy environments. Further, some pet owners may place cotton balls into the ear canals of the dogs to attenuate some noise during festive or noisy events. However, the dogs may be uncomfortable when the cotton balls are placed into their ear canals, and may shake their heads vigorously in a manner that discharges the cotton ball from the dog’s ear canal. The pet owners are burdened with monitoring the behavior of their dogs and continuously checking if their dogs/pets have discharged the cotton balls from their ear canals. In such situations, the pet owners may be unable to fully enjoy any festive events.

Therefore, there exists a long felt need in the art for a protective gear for dogs that prohibits them from being exposed to loud and noisy environments. There is also a long felt need in the art for protective gear for dogs which prohibits pets and dogs from becoming frightened or anxious due to loud sounds. Additionally, there is a long felt need in the art for a protective gear that ensures calm behavior of dogs in noisy and loud environments. Moreover, there is a long felt need in the art for a protective gear that provides a barrier between the noisy environment and the ears of the dogs, and prohibits the animal’s sensitive ears from being exposed to loud sounds. Further, there is a long felt need in the art for protective gear that can be easily worn by the dogs and cannot be removed by randomly shaking their head. Furthermore, there is a long felt need in the art for protective gear for dogs that is comfortable to wear and can be worn for long periods of time, and eliminates the need for the pet owners to continuously monitor their pets if the gear is removed inadvertently. Finally, there is a long felt need in the art for protective gear for dogs that ensures the pet owners remain stress-free while the dogs are comfortable in noisy environments.

The subject matter disclosed and claimed herein, in one embodiment thereof, comprises a protective device for securing a pet’s ears from loud noises. The protective device is designed to protect pets from anxiety-inducing noises such as fireworks, gunshots and thunder by using sound barrier pads. The device comprises a top or exterior layer including opposite first and second ends with a broader central region, a bottom or interior layer symmetrical to the top layer and including opposite first and second ends with a broader central region, the top layer including a logo and a pair of detachably-attached pup ears, the bottom layer including a pair of sleeve-like pockets for receiving and storing sound barrier pads, the first end of the top layer includes a hook fastener and the second end of the bottom layer, includes a loop fastener allowing the top layer to releasably secure to the bottom layer wherein the hook and loop fastener is secured under the chin of the pet, and the sound barrier pads are positioned over the ears to cover the ears of the pet while the device is in use to wrap over the ears and around the pet’s head.

In this manner, the novel protective device of the present invention accomplishes all of the forgoing objectives, and provides a relatively safe, easy, and convenient solution to protect pets from loud and anxiety-inducing noises. The protective gear of the present invention is also pet-friendly, soft and elastic, and covers the ears to passively reduce the sound entering the ears. The device can be used by pet owners, veterinarians and dog shelters, and can protect pets from anxiety-inducing noises such as fireworks, gunshots and thunder. The device also reduces stress for owners, knowing that their pets feel safe and will not run away.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a device for securing a pet’s ears from loud noises. The device is designed to protect pets from anxiety-inducing noises such as fireworks, gunshots and thunder by using sound barrier pads. The device further comprises a top or exterior layer, including opposite first and second ends with a broader central region, a bottom or interior layer symmetrical to the top layer and including opposite first and second ends with a broader central region, the top layer including a logo and a pair of detachably-attached pup ears, the bottom layer including a pair of sleeve-like pockets for receiving and storing sound barrier pads, the first end of the top layer includes a hook fastener and the second end of the bottom layer includes a loop fastener, thereby allowing the top layer to releasably-secure to the bottom layer wherein the hook and loop fastener is secured under the chin of the pet and the sound barrier pads are positioned over the ears to cover ears of the pet while the device is in use, to wrap over the ears and around the pet’s head.

In yet another embodiment, a pet’s ear protection device for protecting the ears of a pet animal from anxiety-inducing noises is disclosed. The device includes a top layer that is visually exposed when the device is worn by a pet, a bottom layer that adheres to the skin of the pet and is positioned between the top layer and the pet, the top layer and the bottom layer can be symmetrical to each other and the top layer overlays the bottom layer, the bottom layer including a pair of sleeve-like pockets for receiving and storing sound barrier ear pads that are configured to passively reduce the ambient and surrounding noise and one end of the top layer can be releasably-attached to the opposite end of the bottom layer to secure the device snugly over the ears and around the head of the pet.

In yet another embodiment of the present invention, a top layer includes a logo between a pair of artificial ears to make the device aesthetically appealing.

In yet another embodiment, the sleeve pockets are not visible from outside and the sound barrier ear pads are removably-stored in the sleeve pockets wherein the sound barrier ear pads reduce the noise entering the ears of the pet by blocking the noise, and thereby alleviating shaking and panic in pets who are fearful of loud sounds.

In yet another embodiment, the sound barrier ear pads cover the ears of the pet and can provide a noise-reduction rating of up to 30 decibels.

In yet another embodiment of the present invention, a method of protecting a pet’s ears from loud noise is disclosed. The method includes the steps of initially positioning a pet’s ear-protecting device over the head of a pet. The protecting device comprises a sewn top layer and bottom layer, one end of the top layer is releasably-securable to the opposite end of the bottom layer, a pair of sleeves for storing soundproof material and a pair of pup or dog ears. The method further includes orienting the device in a flat position for placement over the pet’s ears and head, placing the central portion of the bottom layer on the head and wrapping it over the ears to snugly fit under the chin, and ensuring that the sleeves containing the soundproof material are covering the ears of the pet animal.

In yet another embodiment of the present invention, an animal noise protector device is disclosed. The device includes a hook and loop fastener for securing the device over the ears and around the head of a pet, a pair of sleeve-like pockets to cover the ears, such that the sound barrier ear pads stored in the sleeve-like pockets reduce or mitigate the loud noises before entering the ears of the pet, thereby protecting pets from anxiety-inducing noises such as fireworks, gunshots and thunder.

In yet another embodiment of the present invention, the protecting device is fitted around the neck and over the ears and head of an animal via a hook and loop closure means, snap fastener, button fastener, or buckle fastener. An advantage of this feature is that the device fits an assortment of neck sizes and can be adjusted for a tight fit around a particular animal’s neck.

The device of the present invention is employed to naturally protect the ears of the animal by not directly exposing them to loud sounds. This prohibits ear damage, shaking and panic in pets. The device can be used by pet owners, boarding kennels, veterinarians and dog shelters.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a rear perspective view of one potential embodiment of an ear protector device of the present invention in accordance with the disclosed architecture;

FIG. 1B illustrates a front perspective view of one potential embodiment of an ear protector device of the present invention in accordance with the disclosed architecture;

FIG. 2 illustrates a side perspective view of the one potential embodiment of the ear protector device of the present invention in a deployed position on a dog in accordance with the disclosed architecture;

FIG. 3 illustrates a top perspective view of one potential embodiment of the ear protector device of the present invention in a deployed position on a dog in accordance with the disclosed architecture;

FIG. 4 illustrates a perspective view showing the bottom layer with sleeve pockets and the sound barrier ear pads used in one potential embodiment of the sound-reducing device of the present invention in accordance with the disclosed architecture;

FIG. 5 illustrates a perspective view illustrating how one potential embodiment of the sound-reducing device of the present invention can be deployed on a dog for protection in accordance with the disclosed architecture; and

FIG. 6 illustrates a flow diagram showing exemplary steps performed for a method of protecting the ears of a pet from loud sounds in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there exists a long felt need in the art for protective gear for dogs that prohibits them from being exposed to loud and noisy environments. There is also a long felt need in the art for protective gear for dogs which prohibits the dogs from becoming frightened or anxious due to loud sounds. Additionally, there is a long felt need in the art for a protective gear that ensures calm behavior of dogs in noisy and loud environments. Moreover, there is a long felt need in the art for protective gear that provides a barrier between the noisy environment and the ears of the dogs and prohibits the animal’s sensitive ears from being exposed to loud sounds. Further, there is a long felt need in the art for protective gear that can be easily worn by the dogs and cannot be removed by randomly shaking their heads. Furthermore, there is a long felt need in the art for protective gear for dogs that is comfortable to wear and can be worn for long periods of time, and eliminating the need for the pet owners to continuously monitor their pets if the gear is removed inadvertently. Finally, there is a long felt need in the art for protective gear for dogs that ensures the pets and pet owners remain stress-free while the dogs are comfortable in noisy environments.

The present invention, in one potential embodiment, includes a novel pet ear protection device for protecting the ears of a pet animal from anxiety inducing noises. The device features a top or exterior layer that is visually exposed when the device is worn by a pet and a bottom or interior layer that adheres to the skin of the pet and is positioned between the top layer and the pet. The top layer and the bottom layer can be symmetrical to each other and the top layer overlays the bottom layer. Further, the bottom layer includes a pair of sleeve-like pockets for receiving and storing sound barrier ear pads that are configured to passively reduce or mitigate the noise heard by the pet.

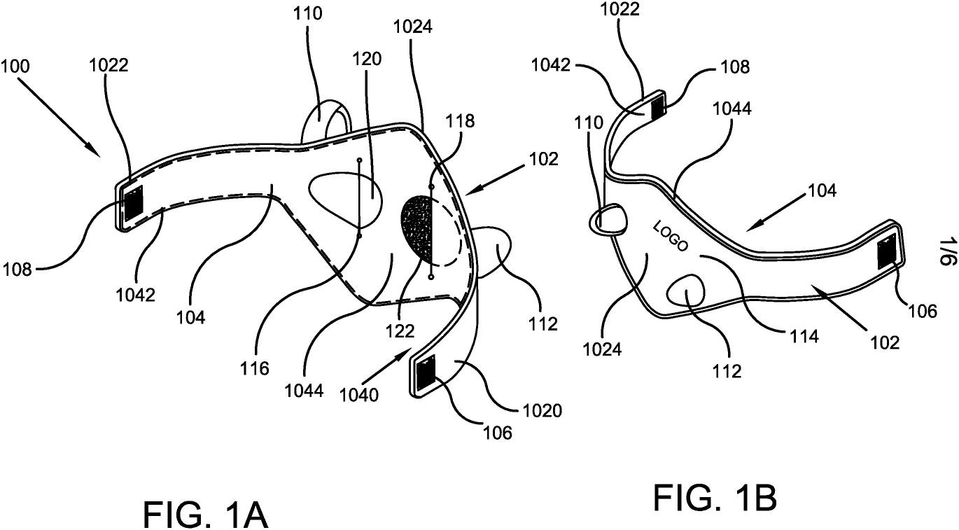

Referring initially to the drawings, FIG. 1A and FIG. 1B illustrate rear and front perspective views of one potential embodiment of an ear protector device of the present invention in accordance with the disclosed architecture. The ear protector device 100 includes a safety device for dogs and other pets and prohibits loud noise from reaching the ears of the animal. The device 100 can be used by pet owners, boarding kennels, breeders, veterinarians and dog shelters for providing safety and protection to pets from anxiety-inducing noises such as fireworks, gunshots and thunder. More specifically, the pet safety device 100 includes a top or exterior layer 102, including a first end 1020 and a second end 1022. The first end 1020 and the second end 1022 are narrower in comparison to the broad central portion 1024. The top layer 102 narrows in a curved manner from the central portion 1024 to both the ends 1020, 1022. Similarly, the device 100 includes a bottom or interior layer 104 that can be symmetrical to the top layer 102 and is adhered to the top layer 102. The top layer 102 and the bottom layer 104 can be sewn to each other and can be of different material, or alternatively can be two layers of the same material. The top layer 102 can be completely overlaid on the bottom layer 104 such that when the device 100 is deployed on a pet such as a dog, the top or exterior layer 102 can be visually exposed and the bottom or interior layer 104 can be positioned between the top layer 102 and skin of the pet. The bottom layer 104 also includes two terminal ends 1040, 1042 with a broader central portion 1044.

The device 100 is suitably sized so as to fit comfortably and snugly over an animal’s ears and against the sides of the animal’s head, and is configured to be secured under the chin area of the animal using a fastener such as a hook or loop material. The first end 1020 of the top layer 102 includes a hook fastener 106 and the opposite end 1042 of the bottom layer 104 includes a loop fastener 108 for securing the device 100. The top layer 102 includes a pair of synthetic pup or dog ears 110, 112. The pup or dog ears 110, 112 can be sewn to the top layer 102 or can be detachably-attached using a snap button, hook or the like. Each pup ear can be positioned on opposing sides of the head of the animal when the device 100 is worn by the animal, providing the appearance of stylistic ears. The pup or dog ears 110, 112 can be of different colors and can be made from a soft and stretchable (i.e. elastic) material. The top layer 102 can also include a logo 114 positioned between the pup ears or dog ears 110, 112 such that the logo 114 is positioned at the center of the head of the animal when the device 100 is deployed on a dog or a pup. The logo 114 can be printed, stitched or attached using an adhesive, and can be used for providing a customized name or logo for a personalized ear protector device 100.

The bottom layer 104 includes a first pocket or cavity 116 and a second pocket or cavity 118 which are disposed such that the first pocket 116 is positioned on a first ear, and the second pocket 118 is positioned on a second ear of the animal wearing the ear protector device 100. The pockets or cavities 116, 118 are sewn to the bottom layer 104 are designed as sleeve-like compartments. Both the first pocket 116 and the second pocket 118 house flexible sound barrier materials/ear pads 120, 122 respectively, that prohibits the loud noise from entering the ears of the animal wearing the device 100. The sound barrier materials can include memory foam securely placed within the pockets 116, 118, which helps to cut down on the volume or decibel level of loud noises. The sound barrier materials are positioned on the ears of the animal in order to provide anti-anxiety ear mufflers to mitigate loud noises.

The ear protecting device 100 slips over the pet’s head and ears like a headband and the stretchable fabric of both the top layer 102 and the bottom layer 104 provides a snug fit with the device secured below the chin. The device 100, employing the sound barrier ear pads, cuts down on the volume of anxiety-triggering noises like those associated with fireworks, gunfire or loud music and help the pet stay calm. The device 100 also acts as an anti-anxiety wrap to soothe the pet.

The soothing device 100 is machine-washable and can be washed after removing the sound barriers from the sleeve-like compartments 116,118. The pup or dog muffler device 100 can be made of a soft, thin washable material which enables the pets to easily move around and lay down while wearing the device 100 without being agitated or uncomfortable. In one illustrative embodiment, the material composition includes 35% Rayon, 60% Polyester, and 5% Spandex. The device 100 comprises a variety of sizes to accommodate all breeds, big and small. A medium variant of the device 100 can include an unstretched length of about 5.0 inches that is stretchable up to about 10.0 inches (i.e. 100% potential increase in length or 2 times in length), and an unstretched width of about 4.0 inches that is stretchable up to about 6.0 inches (i.e. 50% potential increase in width or 1.5 times in width). In a large variant of the device 100, the unstretched length can be about 6.0 inches that is stretchable up to about 12.0 inches (i.e. 100% potential increase in length or 2 times in length), and the unstretched width can be about 6.0 inches that is stretchable up to about 9.0 inches (i.e. 50% potential increase in width or 1.5 times in width). It is to be appreciated that the ear protector device 100, including at least two of the following materials of rayon, polyester and spandex, enables the device 100 to stretch and expand in overall dimensions in order to accommodate a variety of pet head sizes and ear proportions.

The ear-protecting device 100 is effective in absorbing high-frequency sounds in the ultrasonic range and protects the ear canal of the pet wearing the device 100 from damage due to loud sounds. It should be noted that the device 100 of the present invention provides passive sound reduction to guard against hearing damage and provides ultimate comfort for dogs for maximum protection from noise. The device 100 is highly effective in protecting pets, especially dogs, from damaging their sense of hearing from any form of sustained loud noise, such as truck or helicopter transport, gunshots or loud construction sites nearby.

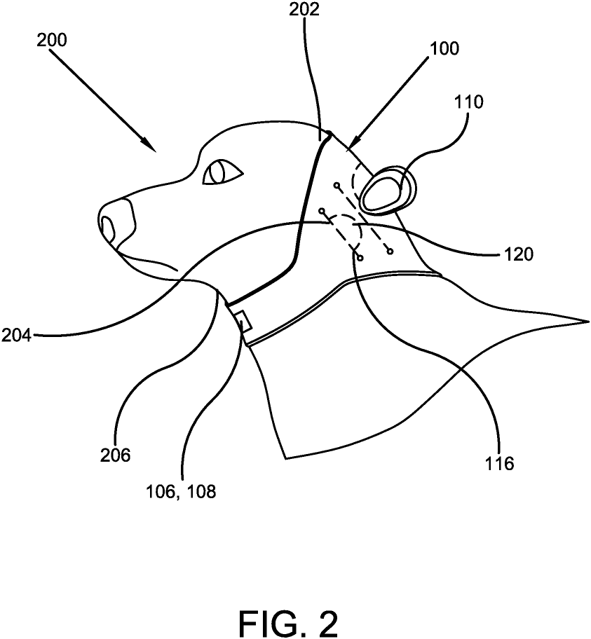

FIG. 2 illustrates a side perspective view of an embodiment of the ear protector device of the present invention in a deployed or mounted position on a dog in accordance with the disclosed architecture. The ear protector device 100, when worn by the dog 200, covers the head 202 and ears 204. When the device 100 is worn, the pup ears 110, 112 are positioned on each side of the head 202. As illustrated, the sound barrier material 120 can be placed inside the sleeve compartment 116 and positioned on the ears 204, thereby preventing loud noise from entering the ears 204 of the dog 200. The device 100 can wrap over the ears 204 and around the animal’s head 202 to snugly fit under the chin 206 of the dog 200. The hook fastener 106 disposed on the top layer 102 and the loop fastener 108 disposed on the bottom layer 104 can be attached to each other below the chin 206 to provide a cover over the ears 204 and head 202 of the dog 200 that fits snugly and securely. The sound barrier material 120 can cover the ears 204 and can protect the animal’s sensitive ears 204 from loud and fear-inducing sounds. The device 100 does not obstruct the head 202 and neck movements of the dog 200.

It is to be understood that the ear protector device 100 can be used to protect pets of various breeds and sizes from loud noises. For example, the device 100 can be used to protect animals with floppy ears that fold over or otherwise cover the animals' ear canals, hairy ears, upright semi-rigid ears and others. As such, the breeds of the animals are for illustration and applicability of the invention, and not to limit same. Indeed, the ear protector device 100 enables protection of other animals, such as, goats, sheep and any other animals whose ears a caregiver or owner may need or have occasion to protect.

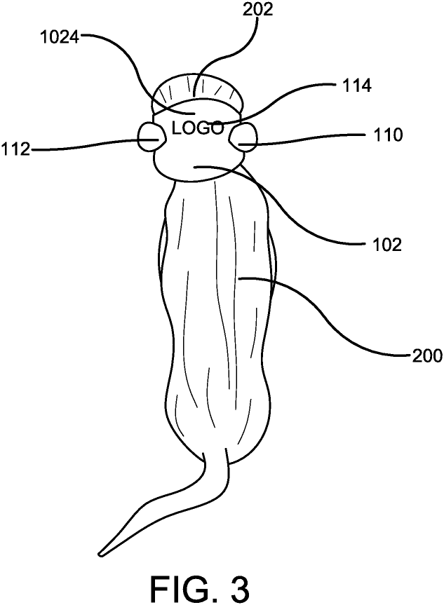

FIG. 3 illustrates a top perspective view of the ear protector device of the present invention in a deployed position on a dog in accordance with the disclosed architecture. The top layer 102 of the device 100 can include a logo 114 that is positioned proximal to the head 202 of the dog 200. On opposing sides of the logo 114, a pair of dog or pup ears 110, 112 can be positioned to accommodate the actual ears of the dog 200. The central part 1024 of the top layer 102 can be configured to enable coverage of the head portion 202 of the dog 200, thus providing adequate securement of the ear protection device 100 to an animal’s head .

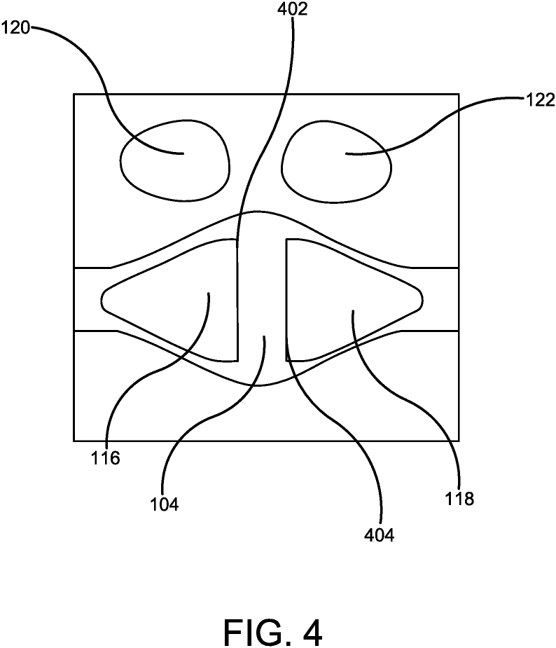

FIG. 4 illustrates a perspective view showing the bottom layer 104 with sleeve pockets and the sound barrier ear pads used in the sound-reducing device 100 of the present invention in accordance with the disclosed architecture. As shown, the bottom layer 104 includes two sleeves 116, 118 that can be anchored to the bottom layer 104. The first sleeve 116 can include an opening 402 and the second sleeve 118 can include an opening 404 for receiving sound barrier pads 120, 122 respectively. The sleeves 116, 118 are positioned on the bottom layer 104 such that the stored sound barrier pads 120, 122 can be inserted or affixed therein to protect the ears of the pet wearing the device, such that loud noises can be reduced (i.e. muffled) to protect pets from anxiety-inducing noises and to reduce associated stress for owners.

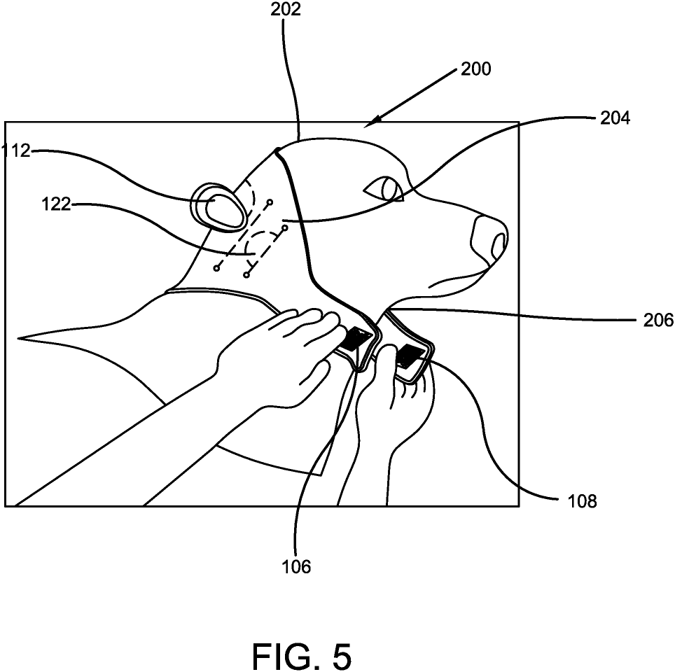

FIG. 5 illustrates a perspective view showing how the soothing and noise-muffling device 100 of the present invention is deployed on a dog for protection in accordance with the disclosed architecture. The device 100 can be placed on the head 202 of the dog 200 and can be wrapped to cover the ears 204. As shown, soundproof pads 122 can thereby be positioned over the ears 204 of an animal, and then the device 100 can be secured under the chin 206 of the dog 200 by fastening the hook fastener 106 and the loop fastener 108 to snugly fit the device 100 to the head of the animal.

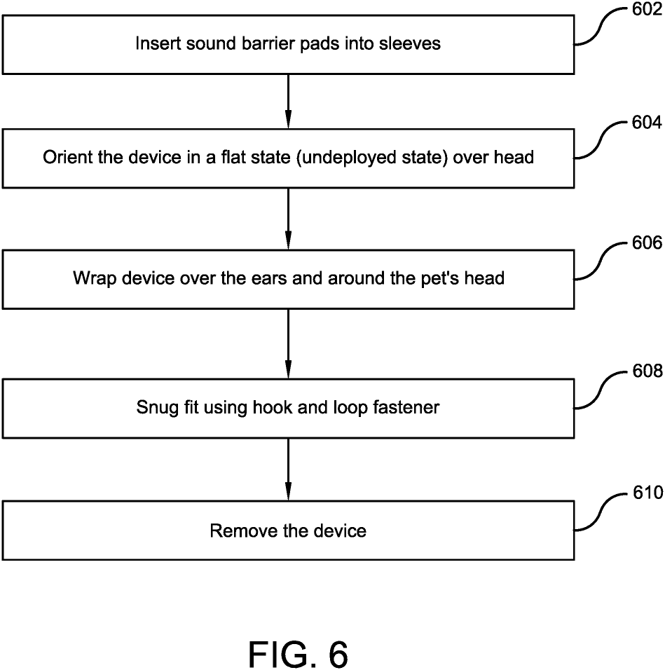

FIG. 6 illustrates a flow diagram showing the exemplary steps performed for a method of protecting the ears of a pet from loud sounds in accordance with the disclosed architecture. It should be understood that the present embodiment states the basic flow performed by a user and additional actions may be used to add additional processes to the basic flow. Initially, sound barrier pads are inserted into the sleeves of the lower layer of the ear-protecting device (Block 602). Then, the device is oriented in a flat state or relatively planar state (i.e. undeployed state) over the head of the pet (Block 604). Thereafter, the device is wrapped over the ears and around the pet’s head. (Block 606). For securing the device, the hook and loop fastener of the device can be secured below the chin of the pet to ensure a snug fit and to ensure that the sound barrier pads are positioned on the ears of the pet (Block 608). Finally, the device can be removed when it is not required by unfastening the hook and loop fastener (Block 610).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ear-protector device”, “sound-reducing device”, “soothing device”, “pet safety device”, “pup muffler device”, “ear protector device”, and “device” are interchangeable and refer to the ear protector device 100 of the present invention.

Notwithstanding the forgoing, the ear protector device 100 of the present invention can be of any suitable size and configuration as is known in the art without affecting the overall concept of the invention, provided that it accomplishes the above-stated objectives. One of ordinary skill in the art will appreciate that the size, configuration and material of the ear protector device 100 as shown in the FIGS. are for illustrative purposes only, and that many other sizes and shapes of the ear protector device 100 are well within the scope of the present disclosure. Although the dimensions of the ear protector device 100 are important design parameters for user convenience, the ear protector device 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments including different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An ear protector and noise muffling device for an animal, the ear protector and noise muffling device comprising:
a top layer including a first end, a second end, and a central portion therebetween, wherein said top layer progressively narrows in a curved manner from said central portion to each of said first end and said second end;
a bottom layer symmetrical to said top layer, wherein said bottom layer is adhered to said top layer, wherein said top layer includes a first material and said bottom layer includes a second material;
an end of said top layer includes a hook fastener and another end of said bottom layer includes a loop fastener for securing said device;
wherein said bottom layer includes a first pocket and a second pocket which are disposed such that said first pocket is aligned with a first ear of the animal and said second pocket is aligned with a second ear of the animal;
wherein said first pocket and said second pocket each include a selectively removable flexible sound barrier ear pad; and
further wherein said sound barrier ear pads include memory foam securely placed within said first pocket and said second pocket for reducing a decibel level of the loud noises entering the first and second ears of the animal wearing the ear protector and noise muffling device.

2. The ear protector and noise muffling device of claim 1, wherein said ear protector device slips over a head of the animal, said first ear and said second ear.

3. The ear protector and noise muffling of claim 1, wherein said first material and said second material are machine washable.

4. The ear protector and noise muffling device of claim 1, wherein said first material is the same as said second material.

5. The ear protector and noise muffling device of claim 1, wherein said first material is different from said second material.

6. The ear protector and noise muffling device of claim 1, wherein said first material and said second material are selected from a group of materials consisting of at least two of a rayon, a polyester and a spandex.

7. The ear protector and noise muffling device of claim 1, wherein said first material and said second material comprise a rayon, a polyester and a spandex.

8. The ear protector and noise muffling device of claim 1, wherein said bottom layer is sewn to said top layer.

9. The ear protector and noise muffling device of claim 1, wherein said first material and said second material are flexible to a stretched size from about 1.5 times to about 2 times an unstretched size.

10. An ear protector and noise muffling device comprising:
a top layer including a first end, a second end, and a central portion therebetween, wherein said top layer progressively narrows in a curved manner from said central portion to each of said first end and said second end;
a bottom layer symmetrical to said top layer, wherein said bottom layer is adhered to said top layer and further wherein said top layer includes a first material and said bottom layer includes a second material;
an end of said top layer includes a hook fastener and another end of said bottom layer includes a loop fastener for securing said device, wherein said bottom layer includes a first pocket and a second pocket which are disposed such that said first pocket is aligned with a first ear of an animal and said second pocket is aligned with a second ear of the animal wearing the ear protector and noise muffling device;
wherein said first pocket and said second pocket each include a selectively removable flexible sound barrier ear pad;
wherein said sound barrier ear pads placed within said first pocket and said second pocket provide for a noise reduction rating of up to 30 decibels for prohibiting loud noises from entering the first and second ears of the animal; and
further wherein said first material and said second material are flexible to a stretched size from about 1.5 times to about 2 times an unstretched size.

11. The ear protector and noise muffling device of claim 10, wherein said ear protector device slips over a head of the animal, said first ear and said second ear.

12. The ear protector and noise muffling device of claim 10, wherein said first material and said second material are machine washable.

13. The ear protector and noise muffling device of claim 10, wherein said first material is the same as said second material.

14. The ear protector and noise muffling device of claim 10, wherein said first material is different from said second material.

15. The ear protector and noise muffling device of claim 10, wherein said first material and said second material are selected from a group of materials consisting of at least two of a rayon, a polyester and a spandex.

16. The ear protector and noise muffling device of claim 10, wherein said first material and said second material comprise a rayon, a polyester and a spandex.

17. The ear protector and noise muffling device of claim 10, wherein said bottom layer is sewn to said top layer.

18. An ear protector and noise muffling device comprising:
a top layer including a first end, a second end, and a central portion therebetween, wherein said top layer progressively narrows in a curved manner from said central portion to each of said first end and said second end;
a bottom layer symmetrical to said top layer, wherein said bottom layer is adhered to said top layer, wherein said top layer includes a first material and said bottom layer includes a second material, and further wherein said bottom layer includes a first pocket and a second pocket which are disposed such that said first pocket is aligned with a first ear of a dog and said second pocket is aligned with a second ear of the dog;
wherein said first pocket and said second pocket each include a selectively removable flexible sound barrier ear pad;
wherein said first material and said second material are flexible to a stretched size from about 1.5 times to about 2 times an unstretched size; and
further wherein said sound barrier ear pads include memory foam securely placed within said first pocket and said second pocket for reducing a decibel level of the loud noises entering the ears of the dog wearing the ear protector and noise muffling device.

19. The ear protector and noise muffling device of claim 18, wherein said ear protector device slips over a head of the dog, said first ear and said second ear.

20. The ear protector and noise muffling device of claim 19, wherein said first material and said second material are machine washable.
